(19) United States
(12) Patent Application Publication
(10) Pub. No.: US 2003/0067945 A1
(43) Pub. Date: Apr. 10, 2003

(54) Tunable optical waveguide laser using rare-earth dopants

(75) Inventors: Renyuan Gao, Strafford, PA (US); Anthony F. Garito, Radnor, PA (US)

Correspondence Address: Finnegan, Henderson, Farabow,, Garrett & Dunner, L.L.P., 1300 I Street, N.W., Washington, DC, 20005-3315, US

(73) Assignee: Photon-X, Inc.

(21) Appl. No.: 10/266,637

(22) Filed: Oct. 9, 2002

Related U.S. Application Data
(60) Provisional application No. 60/328,041, filed on Oct. 9, 2001.

(51) Int. Cl. H01S 3/23; G02B 6/10; H01S 3/04

(52) U.S. Cl. 372/7; 385/129; 372/34

(57) ABSTRACT

A tunable waveguide laser includes a laser cavity with a length of polymer waveguide doped with rare-earth elements and having reflectors at either end. The output wavelength of the waveguide laser depends on the configuration of the reflectors, which are generally optical gratings. Temperature control elements, such as resistive heaters, are used to adjust the temperature of the reflectors. The change in temperature causes a change in the configuration of the reflectors resulting in a shift in output wavelength. The temperature of the reflectors are controlled to achieve a desired output wavelength.

### CROSS REFERENCE TO RELATED APPLICATION

Applicants claim the benefit under 35 U.S.C. § 119(e) based on prior-filed, copending U.S. Provisional Patent Application No. 60/328,041 filed Oct. 9, 2001, which is relied on and incorporated herein by reference.

### DESCRIPTION OF THE INVENTION

1. Field of the Invention

This invention relates to lasers, and more particularly, to tunable optical waveguide lasers using polymer materials and rare-earth dopants.

2. Background of the Invention

Lasers have been formed using various stimulated emissions optical media, including crystals, gases, glasses, organic dyes, semiconductors, and plasmas. Various waveguide lasers have been developed in both planar and cylindrical waveguide forms as optical fiber technology and its uses have proliferated. As a result, waveguide lasers have become an important component in high-performance fiber-optical communication systems.

In general, waveguide lasers are comprised of a length of waveguide core containing dopants such as erbium disposed between two reflectors. When a pump signal is supplied to the waveguide laser, repeated stimulated emission from the dopants and internal reflection from the reflectors result in a more powerful laser output signal. The output wavelength depends on the type of dopants and the properties of the reflectors at both ends. These attributes are generally set at the time of production. Because the factors affecting the wavelength are preselected and built into the device, most waveguide lasers have a predefined output wavelength.

A tunable or reconfigurable waveguide laser is desirable because it allows a single waveguide laser to be used in a variety of applications. Additionally, such a device could be dynamically reconfigured to adjust to changing needs of the system in which it is employed. Though some attempts have been made to provide a tunable waveguide laser, the devices and methods suffer from disadvantages. In particular, tunable waveguide lasers using glass as a waveguide material are tunable only over a small range of wavelengths, have slow response times, and require excessive energy to tune. Hence, there is a need for a low-cost, high-performance, tunable waveguide laser that solves the problems of known devices.

### SUMMARY OF THE INVENTION

In accordance with the invention, there is provided a tunable waveguide laser comprising a waveguide core comprised of polymer material and at least one dopant; a waveguide cladding surrounding the waveguide core; a first reflector formed near a first end of the waveguide core; a second reflector formed near a second end of the waveguide core, wherein at least the second reflector is an optical grating; and at least one temperature control element capable of changing a temperature of at least the second reflector.

Also in accordance with the invention, there is provided a method of fabricating a tunable waveguide laser comprising forming a first cladding layer comprised of polymer on a substrate; forming a channel in the first cladding layer; forming a waveguide core in the channel, wherein the waveguide core is comprised of polymer material and at least one element from the lanthanide series; forming a first reflector near a first end of the waveguide core; forming a second reflector near a second end of the waveguide core, wherein the second reflector is an optical grating; forming a second cladding layer comprised of polymer over the waveguide core; and forming at least one temperature control element capable of changing the temperature of at least the second reflector on the second cladding layer.

Further, in accordance with the invention, there is provided a method of fabricating a tunable waveguide laser comprising providing a waveguide core comprised of polymer material and at least one element from the lanthanide series; providing a waveguide cladding surrounding the waveguide core; forming a first reflector near a first end of the waveguide core; forming a second reflector near a second end of the waveguide core, wherein at least the second reflector is an optical grating; and forming at least one temperature control element capable of changing the temperature of at least the second reflector to produce a desired output wavelength.

Further, in accordance with the invention, there is provided a method of tuning a waveguide laser comprising providing a waveguide core comprised of polymer material and at least one element from the lanthanide series; providing a waveguide cladding surrounding the waveguide core; providing a first reflector near a first end of the waveguide core; providing a second reflector near a second end of the waveguide core, wherein at least the second reflector is an optical grating; and changing the temperature of at least the second reflector to produce a desired output wavelength.

Additionally, in accordance with the invention, there is provided a method of fabricating a tunable waveguide laser comprising forming a first cladding layer comprised of polymer material on a substrate; forming a layer of waveguide core material on the first cladding layer, wherein the waveguide core material is comprised of polymer material and at least one element from the lanthanide series; patterning the layer of waveguide core material to form a waveguide core; forming a first reflector near a first end of the waveguide core; forming a second reflector near a second end of the waveguide core, wherein the second reflector is an optical grating; forming a second cladding layer comprised of polymer material over the waveguide core; and forming at least one temperature control element capable of changing the temperature of at least the second reflector on the second cladding layer.

Additional features and advantages of the invention will be set forth in part in the description which follows, and in part will be obvious from the description, or may be learned by practice of the invention.

The accompanying drawings, which are incorporated in and constitute a part of this specification, illustrate embodiments of the invention and together with the description, serve to explain the principles of the invention.

It is to be understood that both the foregoing general description and the following detailed description are exemplary and explanatory only and are not restrictive of the invention, as claimed.

### BRIEF DESCRIPTION OF THE DRAWINGS

FIG. 1 is a longitudinal cross sectional view of a tunable waveguide laser according to the present invention.

FIGS. 2(a)-2(c) are longitudinal cross sectional views of gratings according to the present invention.

FIGS. 3(a)-3(g) are cross-sectional views showing the steps of a first method of manufacturing a tunable waveguide laser consistent with the present invention.

FIGS. 4(a)-4(g) are cross-sectional views showing the steps a second method of manufacturing a tunable waveguide laser consistent with the present invention.

FIG. 5 is a longitudinal cross sectional view of a tunable waveguide laser according to the present invention.

FIG. 6 is a graph of exemplary outputs of a tunable waveguide laser according to the present invention.

### DESCRIPTION OF THE EMBODIMENTS

Reference will now be made in detail to the present embodiments of the invention, examples of which is are illustrated in the accompanying drawings. Wherever possible, the same reference numbers will be used throughout the drawings to refer to the same or like parts.

The present invention relates to lasers, and more particularly, to tunable optical waveguide lasers using polymer materials and rare-earth dopants. Such tunable waveguide lasers comprise a laser cavity with a length of polymer waveguide doped with rare-earth elements and having reflectors at either end. The output wavelength of the waveguide laser depends on the configuration of the reflectors, which are generally optical gratings. Temperature control elements, such as resistive heaters, are used to adjust the temperature of the reflectors. A change in temperature of the reflectors causes a change in the configuration of the reflectors, resulting in a shift in output wavelength. Thus by adjusting the temperature of the reflectors, a desired output wavelength can be achieved.

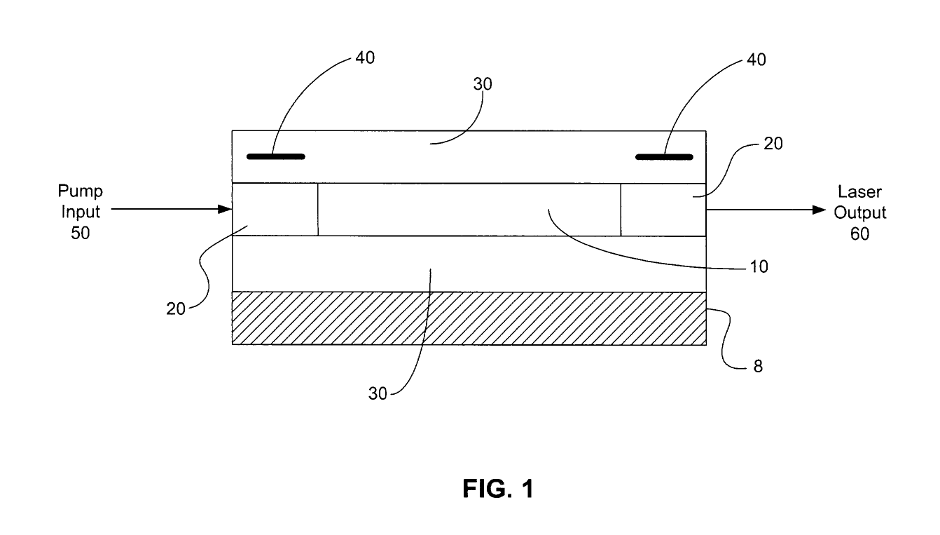

FIG. 1 is a longitudinal cross section of an embodiment of a tunable optical waveguide laser of the present invention. The device comprises a waveguide core 10 having reflectors 20 at each end, surrounded by a cladding material 30 and having temperature control elements 40 near the reflectors 20. The device is adapted to receive a pump laser input 50 and produce a laser output 60. The invention is further described below.

The waveguide core 10 is a polymer-based material such as, for example, halogenated polymers, fluoropolymers and perfluoro polymers. Reference is made to U.S. Pat. No. 6,292,292 to Garito et al. and to U.S. patent application Ser. No. 60/314,902, the entire contents of which are hereby incorporated by reference, for a detailed description of such halogenated polymers, fluoropolymers and perfluoro polymers. Within the waveguide core 10 are one or more dopants capable of stimulated emission. The dopants are rare-earth metals from the lanthanide series, such as erbium, ytterbium, neodymium, holmium, lanthanum, cerium, promethium, gadolinium, lutetium, europium, samarium, thulium, dysprosium, and terbium. Because each of the dopants has a distinctive stimulated emission spectrum, the dopants are selected to achieve a desired stimulated emission spectrum. The length of the doped waveguide core 10 between the reflectors 20 is long enough to provide continuous spectrum cavity modes. As a result, the length of the waveguide core 10 between the reflectors 20 is generally greater than 1 mm. The length of the waveguide core 10 is selected so that the dependence of the output wavelength of the laser on the length of the laser cavity is minimized. This ensures that the output wavelength of the laser depends primarily on the characteristics of the reflectors 20 as later described. Because the output energy depends, at least in part, on the length of the waveguide core and the density of dopants, the length may also be chosen to select an output wavelength linewidth. For a given resonant wavelength, increasing the length of the cavity results in narrower output wavelength linewidth. The waveguide core may be a fiber or planar waveguide.

The cladding material 30 may include any material suitable for waveguide cladding, but is preferably a polymer-based material such as, for example, halogenated polymers, fluoropolymers and perfluoro polymers disclosed in U.S. Pat. No. 6,292,292 to Garito et al. and U.S. patent application Ser. No. 60/314,902. Generally, the cladding material 30 has an index of refraction that is 100.3%-103% of the value of the index of refraction of the waveguide core 10. One or more heating elements 40 are formed in the cladding 30 near one or both reflectors 20. Alternatively, though not shown in FIG. 1, the heating elements 40 could be formed on the outside surface of the cladding 30. The heating elements 40 are preferably resistive heating elements capable of locally applying heat to the reflectors 20 or portions thereof when electrical current is supplied.

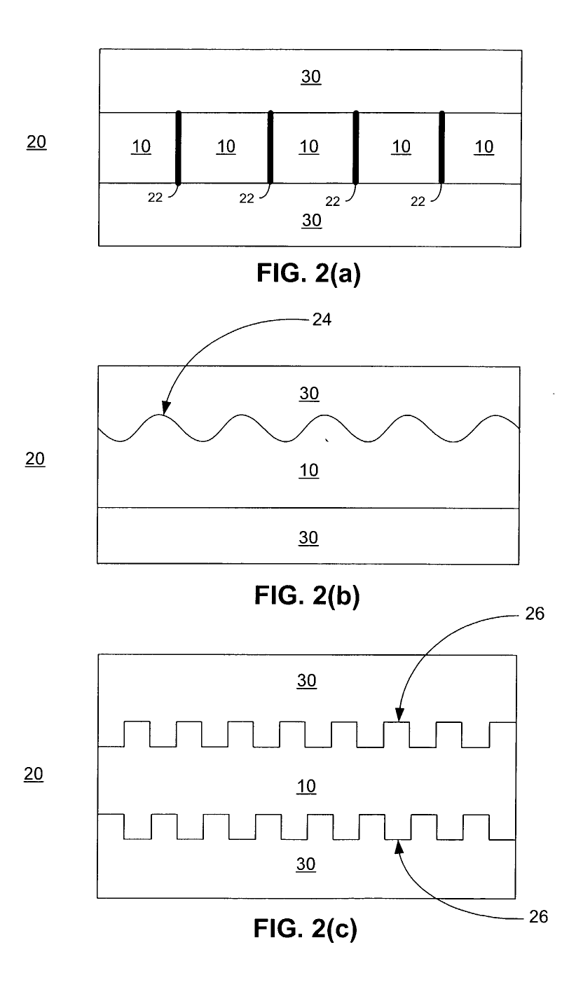

The reflectors 20 are preferably both optical gratings. Alternatively, the input side reflector may be a wavelength-selective mirror that is highly or completely reflective to light within the laser cavity at wavelengths that include the laser operation range of the waveguide laser. The grating or gratings are preferably perturbations in the index of refraction of the waveguide core. However, other types of gratings may be used. FIG. 2(a) shows a grating 20 in longitudinal cross-section, according to the present invention, comprised of grating layers 22 that have an index of refraction that differs from the surrounding waveguide core 10. It is desirable that the index of refraction of the grating layers 22 be 0.01%-1% variations from the index of refraction of the adjacent waveguide core 10. The grating layers 22 are generally comprised of the same polymer material as the surrounding waveguide core, but have been exposed to radiation such as ultraviolet light, electron beam, β ray and γ rays to alter the molecular structure of the material to change the index of refraction. Alternatively, the gratings of the present invention can comprise corrugations of the vertical or horizontal dimensions of the waveguide core. FIG. 2(b) is a side view longitudinal cross-section of a grating 20 according to the present invention comprising corrugations 24 of the vertical dimensions of the waveguide core 10. FIG. 2(c) is a top view longitudinal cross-section of a grating 20 according to the present invention comprising corrugations 26 of the horizontal dimensions of the waveguide core 10. In both FIGS. 2(b) and 2(c), the corrugations 24, 26 of the waveguide core surface are generally 0.1-10% of the waveguide core thickness. The corrugations 24, 26 of the surface of the waveguide core 10 give the gratings shown in FIGS. 2(b) and 2(c) an effective index of refraction that depends on the dimensions of the corrugations 24, 26. Thus the gratings of FIGS. 2(a), 2(b), or 2(c) all have an effective index of refraction that differs from the effective index of refraction of the adjacent waveguide core 10.

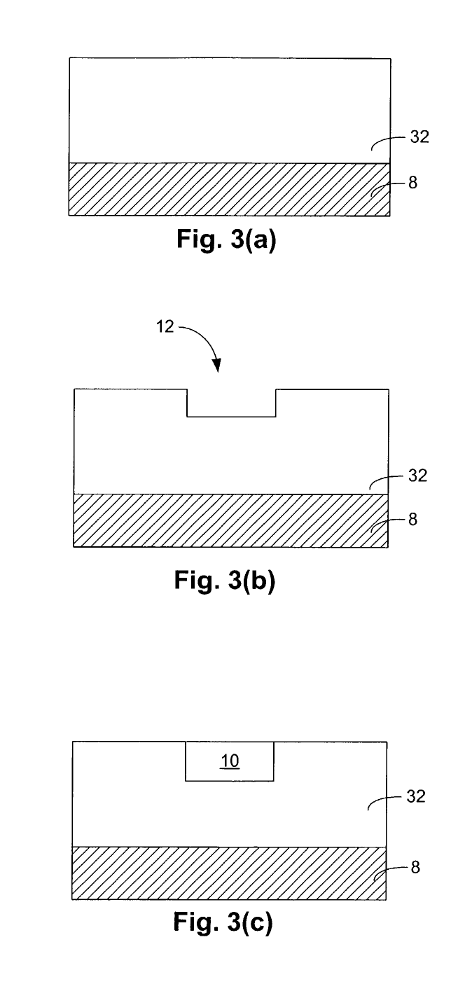

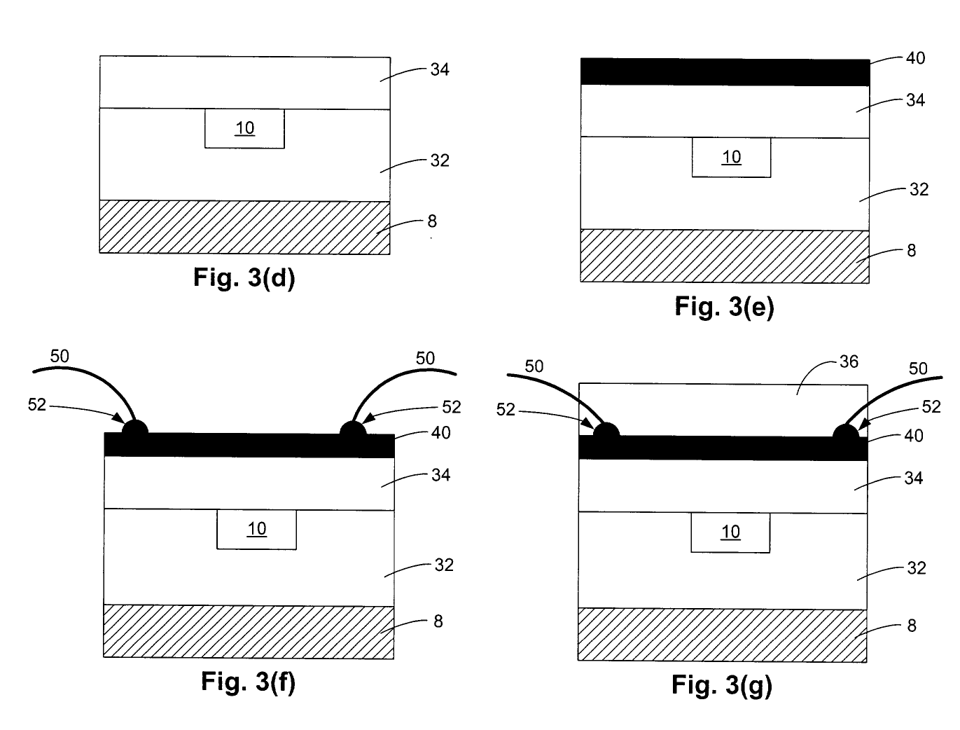

FIGS. 3(a)-3(g), each of which represents a cross sectional view, illustrate the steps of manufacturing an embodiment of a tunable waveguide laser according to the present invention. First, as shown in FIG. 3(a), a first layer 32 of cladding is formed on a silicon or polymer substrate 8. The first cladding layer 32 is formed by dissolving a polymer material such as Hyflon®, in a known solvent, such as Fluorinert® FC-40, and spin coating the material onto the substrate to form the structure shown in FIG. 3(a). As shown in FIG. 3(b), a channel 12 is then formed in the first cladding layer 32 using a process such as reactive ion dry etching or any other suitable method known to those skilled in the art. Next, a polymer waveguide core 10 material is dissolved in a known solvent, such as Fluorinert® FC-40, and applied using a spin coat method. Dopants are embedded in the waveguide core 10 using a known process such as, for example, that disclosed in U.S. Pat. No. 6,292,292 to Garito et al. and U.S. patent application Ser. No. 60/314,902. Some of the waveguide core 10 material is then removed using reactive etching, such that the waveguide core 10 material is disposed only in the channel 12 as shown in FIG. 3(c). Next, gratings are formed within a portion of the waveguide core material using a known method such as, for example, applying radiation to areas of the waveguide in which the gratings are to be formed. The process is similar to the process of forming gratings in silica fibers disclosed in Hecht, Understanding Fiber Optics, Third Edition (1999), p. 131. Then, as shown in FIG. 3(d), a second layer 34 of cladding material is added using the same process used to form the first cladding layer 32. FIG. 3(e) shows the addition of temperature control elements 40. The temperature control elements 40 may be formed by applying a prefabricated metal film or depositing a layer of resistive metal by a known process such as, for example, a vapor deposition technique. The temperature control elements 40 are patterned so that they are positioned substantially over the gratings 20. Additionally, connectors for electrically connecting the heating elements to a power source, such as bonding pads or electrodes, may also be patterned into the temperature control elements 40. In FIG. 3(f), connection wires 50 have been electrically connected to the temperature control elements 40 by solder 52. Lastly, a third cladding layer 36 is formed using the same method used to form the first and second cladding layers 32, 34. The result, shown in FIG. 3(g), represents a cross section of a grating region of an embodiment of the present invention. Though not shown in the figures, one of the gratings may be a wavelength-selective mirror that is highly or completely reflective to light within the laser cavity at wavelengths that include the laser operation range of the waveguide laser. The mirror may be formed within the waveguide core itself by exposing the region to radiation to change the index of refraction or other known method of creating a mirror in a waveguide. Alternatively, the gratings shown in FIGS. 3(a)-3(g) may be replaced with gratings shown in FIG. 2(b) or 2(c) by selectively etching the waveguide cladding or the waveguide core to achieve the desired corrugations.

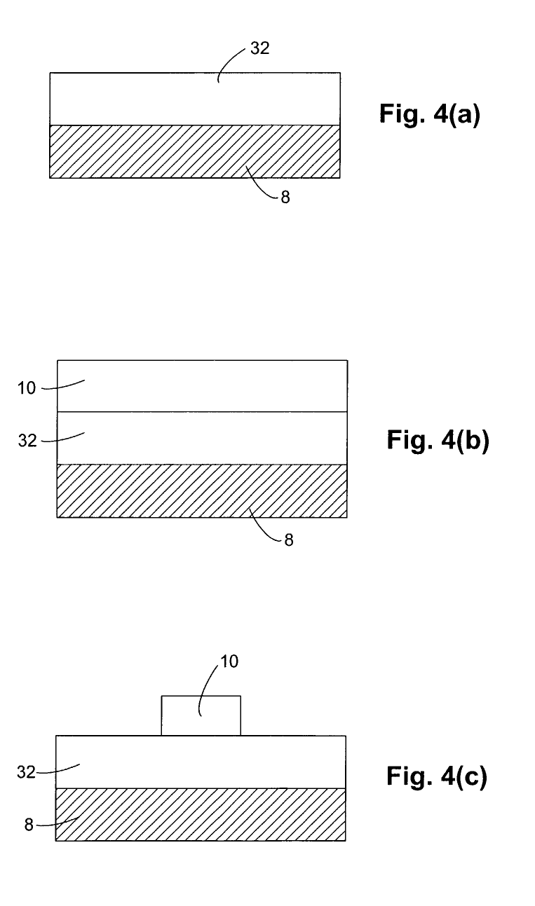

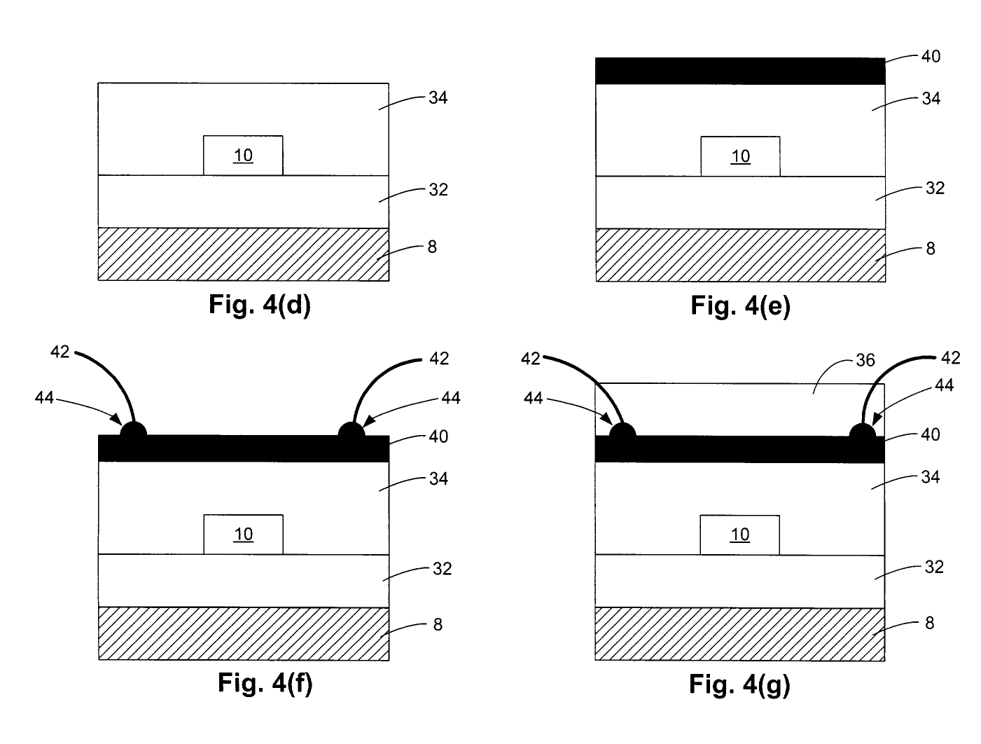

An alternative method of manufacturing an embodiment of a tunable waveguide laser according to the present invention is shown in FIGS. 4(a)-4(g), each of which represents a cross section. First, as shown in FIG. 4(a), a first layer 32 of cladding is formed on a silicon or polymer substrate 8. The first cladding layer 32 is formed by dissolving a polymer material such as Hyflon®, in a known solvent, such as Fluorinert® FC-40, and spin coating the material onto the substrate to form the structure shown in FIG. 4(a). Then, a polymer waveguide core 10 material is dissolved in a known solvent, such as Fluorinert® FC-40®, and applied using a spin coat method to achieve the structure shown in FIG. 4(b). The waveguide core 10 layer is then etched as shown in FIG. 4(c) using a known process such as reactive ion dry etching or any other method known to those skilled in the art. Either before or after the step of etching the waveguide core 10, gratings are formed within a portion of the waveguide core material 10 using the process described above with reference to FIGS. 3(c)-3(d). Then, as shown in FIG. 4(d), a second layer 34 of cladding material is added using the same process used to form the first cladding layer 32. FIG. 4(e) shows the addition of temperature control elements 40 using the same processes described in reference to FIG. 3(e). In FIG. 4(f), connection wires 50 have been electrically connected to the temperature control elements 40 by solder 52. Lastly, as shown in FIG. 4(g), a third cladding layer 36 is formed using the same method used to form the first and second cladding layers 32, 34.

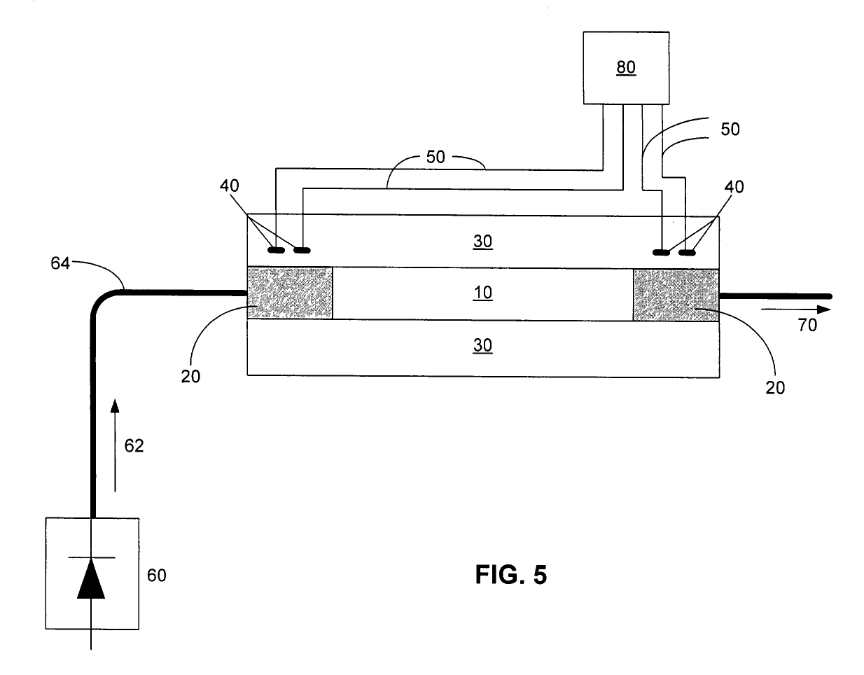

Operation of an embodiment of the tunable waveguide laser of the present invention is explained with reference to FIG. 5. A pump laser 60, connected to the input of the laser by an optical fiber 64, supplies an input signal 62 to the waveguide core 10 through one end of the tunable waveguide laser. The pump laser signal 62 passes through one of the gratings 20 into the waveguide core 10 containing one or more dopants. The pump laser signal 62 is absorbed by the dopants, which undergo stimulated emission. The wavelength of the laser output 70 depends on the wavelength reflected back into the laser cavity by the gratings 20. The gratings 20 are highly reflective to a narrow band of wavelengths centered around a peak. The reflected wavelength and hence the wavelength of the laser output 70 depends both on the difference in the indices of refraction between the waveguide core 10 and the gratings 20 and on the spacing between the grating layers within each grating 20. The output wavelength of the laser is dependent on the spacing (d) between the gratings 20, and the effective index of refraction of the waveguide (n) by the following equation: λ=2dn. For example, a waveguide laser with refractive index n=1.3 and grating spacing d=596 nm, has an output wavelength of 1550 nm.

The tuning of the output laser wavelength relies on both the effective refractive index of the waveguide and the grating spacing:

Δλ=2nΔd+2dΔn

where the change in spacing Δd and refractive index Δn can both be adjusted by changing the temperature locally at the grating region 20 or changing the temperature of the entire device.

The reflectivity of the grating at the output end of the waveguide laser affects the lasing threshold of the waveguide laser. Where the reflectivity of the grating at the input of the waveguide laser is R₁, the reflectivity of the grating at the output of the waveguide laser is R₂, and the single pass gain G of the cavity is a function of the pump power G(p), the lasing threshold is

$$2 G ( p ) \frac{( 1 - {R}_{1} ) ( 1 - {R}_{2} )}{} = 1$$

$$G ( p ) = \frac{1}{2 ( 1 - {R}_{1} ) ( 1 - {R}_{2} )} .$$

The temperature control elements 40 allow the output 70 wavelength to be tuned. In this embodiment, both the waveguide core 10 and the cladding 30 are comprised of polymers. Polymers have a high thermo-optical coefficient compared to other waveguide materials such as glass. This means that applying a given amount of heat to the polymer waveguide material results in a larger change in the index of refraction compared to other materials such as glass. Further, polymers have a high thermal expansion coefficient such that when heat is applied to the polymer material it expands. Polymers also have relatively low thermal conductivity, such that a small amount of heat energy applied to a point results in efficient local heating around the application point. As a result, polymers are well suited for use in tuning the waveguide laser of the present invention because relatively small amounts of heat can be locally applied to significantly change the index of refraction and the spacing between grating layers.

Because of the properties of the polymers used in the waveguide core and the cladding, the application of heat changes both the index of refraction and distance between grating layers. This results in a shift in the wavelength reflected back into the laser cavity by the grating 20. The change in the reflected wavelength results in a corresponding change in the laser oscillation wavelength and the output 70 wavelength of the waveguide laser. Thus, by changing the temperature of the gratings, the output wavelength of the waveguide laser is tunable.

A control system 80 comprising a source of electrical current may be used in the present invention to regulate the output 70 wavelength of the laser. The control system 80 is preferably microprocessor based and may include a memory and other operational circuitry. Preferably, heat is applied to the gratings 20 by resistive heating elements 40 that produce heat when electric current is applied through connecting wires 50. When current is not supplied to the heating elements 40, the temperature of the gratings 20 decrease to the ambient operating temperature of the device. The control system 80 may apply a predetermined level of current to achieve a desired output 70 wavelength. Alternatively, the output 70 of the laser may be sampled using a tap coupler or similar device (not shown) to supply a portion of the output signal to a spectrometer or similar instrument (not shown) to determine the output 70 wavelength. Feedback circuitry within the control system then uses the determined output wavelength to select and supply current at a level that maintains a desired output 70 wavelength.

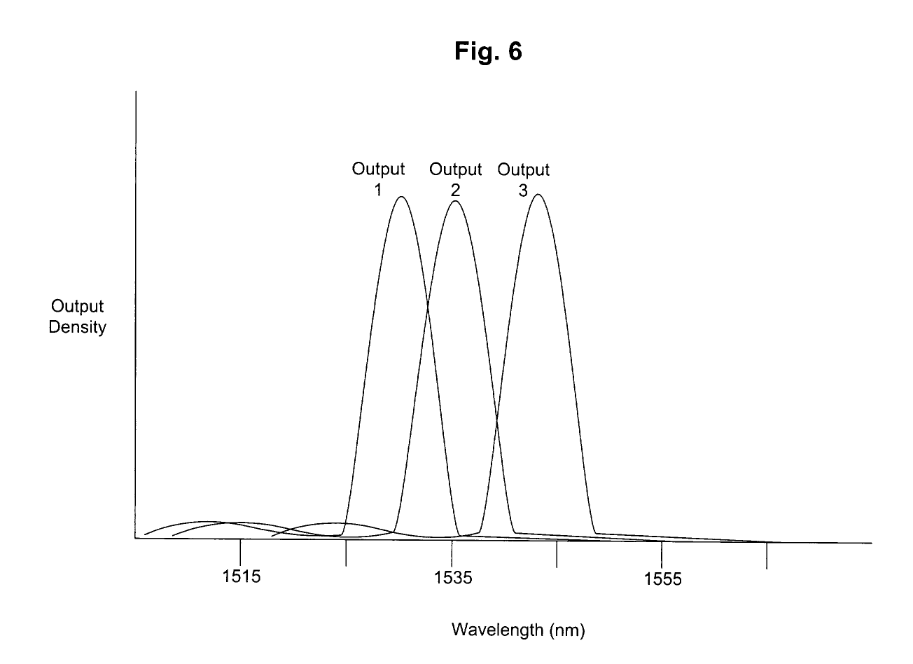

FIG. 6 shows a graph of an exemplary output 70 of the tunable waveguide laser of the present invention at three different temperatures. The output 70 is centered around a peak wavelength that can be shifted by changing the temperature of the gratings 20. Output 1 is the result of the waveguide laser, including the gratings 20, operating at a first temperature. The temperature of the gratings 20 is increased by 30° C. over the first temperature to achieve output 2. Output 3 is the result of increasing the temperature of the gratings 20 by 60° C. over the first temperature. Increasing the temperature of the gratings 20 by 1-100° C. may be accomplished by supplying one to several hundred milliwatts of energy to the heating elements 40. These temperature changes can shift the output 70 wavelength of the waveguide laser by 10-20 nanometers. The wavelength of the output 70 of the device can be adjusted virtually in real time with response times currently on the order of 50 milliseconds.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A tunable waveguide laser comprising:
a waveguide core comprised of polymer material and at least one dopant;
a waveguide cladding surrounding the waveguide core;
a first reflector formed near a first end of the waveguide core;
a second reflector formed near a second end of the waveguide core, wherein at least the second reflector is an optical grating; and
at least one temperature control element capable of changing a temperature of at least the second reflector.

2. The tunable waveguide laser of claim 1, wherein the polymer material of the waveguide core comprises a halogenated polymer.

3. The tunable waveguide laser of claim 2, wherein the halogenated polymer is a fluoropolymer.

4. The tunable waveguide laser of claim 1, wherein the waveguide cladding is comprised of polymer material.

5. The tunable waveguide laser of claim 4, wherein the polymer material of the waveguide cladding comprises a halogenated polymer.

6. The tunable waveguide laser of claim 5, wherein the halogenated polymer is a fluoropolymer.

7. The tunable waveguide laser of claim 1, wherein the polymer material of the waveguide core comprises a perfluoro polymer.

8. The tunable waveguide laser of claim 4, wherein the polymer material of the waveguide cladding comprises a perfluoro polymer.

9. The tunable waveguide laser of claim 1, wherein the at least one dopant is an element selected from the lanthanide series.

10. The tunable waveguide laser of claim 1, wherein the first reflector is an optical grating.

11. The tunable waveguide laser of claim 1, wherein the first reflector is a wavelength selective mirror that is reflective to light within the waveguide core.

12. The tunable waveguide laser of claim 1, wherein the at least one temperature control element is disposed within the waveguide cladding.

13. The tunable waveguide laser of claim 1, further comprising a system for controlling the temperature of the at least one temperature control element.

14. The tunable waveguide laser of claim 13, wherein the system is capable of analyzing an output wavelength and adjusting the temperature of the at least one temperature control element to maintain a specified output wavelength.

15. The tunable waveguide laser of claim 1, wherein the waveguide core is a planar waveguide core.

16. The tunable waveguide laser of claim 1, wherein the waveguide laser is formed on a substrate.

17. The tunable waveguide laser of claim 16, wherein the substrate is a polymer.

18. The tunable waveguide laser of claim 1, wherein the first end of the waveguide core is coupled to a pump laser source.

19. A method of fabricating a tunable waveguide laser comprising:
forming a first cladding layer comprised of polymer material on a substrate;
forming a channel in the first cladding layer;
forming a waveguide core in the channel, wherein the waveguide core is comprised of polymer material and at least one element from the lanthanide series;
forming a first reflector near a first end of the waveguide core;
forming a second reflector near a second end of the waveguide core, wherein the second reflector is an optical grating;
forming a second cladding layer comprised of polymer material over the waveguide core; and
forming at least one temperature control element capable of changing the temperature of at least the second reflector on the second cladding layer.

20. The method of fabricating a waveguide laser of claim 19, further comprising providing a system for controlling the temperature of the at least one temperature control element.

21. A method of fabricating a tunable waveguide laser comprising:
providing a waveguide core comprised of polymer material and at least one element from the lanthanide series;
providing a waveguide cladding surrounding the waveguide core;
forming a first reflector near a first end of the waveguide core;
forming a second reflector near a second end of the waveguide core, wherein at least the second reflector is an optical grating; and
forming at least one temperature control element capable of changing the temperature of at least the second reflector to produce a desired output wavelength.

22. The method of fabricating a waveguide laser of claim 21, wherein the polymer material of the waveguide core comprises a halogenated polymer.

23. The method of fabricating a waveguide laser of claim 22, wherein the halogenated polymer is a fluoropolymer.

24. The method of fabricating a waveguide laser of claim 21, wherein the waveguide cladding is comprised of polymer material.

25. The method of fabricating a waveguide laser of claim 24, wherein the polymer material of the waveguide cladding comprises a halogenated polymer.

26. The method of fabricating a waveguide laser of claim 25, wherein the halogenated polymer is a fluoropolymer.

27. The method of fabricating a waveguide laser of claim 21, wherein the polymer material of the waveguide core comprises a perfluoro polymer.

28. The method of fabricating a waveguide laser of claim 24, wherein the polymer material of the waveguide cladding comprises a perfluoro polymer.

29. The method of fabricating a waveguide laser of claim 21, wherein the first reflector is an optical grating.

30. The method of fabricating a waveguide laser of claim 21, wherein the first reflector is a wavelength selective mirror that is reflective to light within the waveguide core.

31. The method of fabricating a waveguide laser of claim 21, further comprising providing a system for controlling the temperature of the at least one temperature control element.

32. The method of fabricating a waveguide laser of claim 31, wherein the system is capable of sampling an output wavelength and adjusting the temperature of the one or more temperature control elements to maintain a specified output wavelength.

33. The method of fabricating a waveguide laser of claim 21, wherein the waveguide core is a planar waveguide core.

34. The method of fabricating a waveguide laser of claim 21, wherein the waveguide laser is formed on a substrate.

35. The method of fabricating a waveguide laser of claim 34, wherein the substrate is a polymer substrate.

36. A method of tuning a waveguide laser comprising:
providing a waveguide core comprised of polymer material and at least one element from the lanthanide series;
providing a waveguide cladding surrounding the core;
providing a first reflector near a first end of the waveguide core;
providing a second reflector near a second end of the waveguide core, wherein at least the second reflector is an optical grating; and
changing the temperature of at least the second reflector to produce a desired output wavelength.

37. A method of fabricating a tunable waveguide laser comprising:
forming a first cladding layer comprised of polymer material on a substrate;
forming a layer of waveguide core material on the first cladding layer, wherein the waveguide core material is comprised of polymer material and at least one element from the lanthanide series;
patterning the layer of waveguide core material to form a waveguide core;
forming a first reflector near a first end of the waveguide core;
forming a second reflector near a second end of the waveguide core, wherein the second reflector is an optical grating;
forming a second cladding layer comprised of polymer material over the waveguide core; and
forming at least one temperature control element capable of changing the temperature of at least the second reflector on the second cladding layer.

38. The method of fabricating a waveguide laser of claim 37, further comprising providing a system for controlling the temperature of the at least one temperature control element.
